(19) United States
(12) Patent Application Publication
(10) Pub. No.: US 2009/0062963 A1
(43) Pub. Date: Mar. 5, 2009

(54) Cooling Fan Controller and Cooling Fan Controller for Working Machinery

(76) Inventor: Yoshihiko Hayashi, Tokyo (JP)

Correspondence Address: BIRCH STEWART KOLASCH & BIRCH, PO BOX 747, FALLS CHURCH, VA, 22040-0747, US

(21) Appl. No.: 12/224,422

(22) PCT Filed: Mar. 8, 2007
(86) PCT No.: PCT/JP2007/054569

§ 371 Date: Aug. 27, 2008

(51) Int. Cl. G05B 15/00; G05D 23/00

(52) U.S. Cl. 700/275; 700/299

(57) ABSTRACT

A cooling fan controller is provided for controlling the revolving speed of a cooling fan that introduces outside air as a cooling wind to cool a fluid being cooled; in order to optimally control the revolving speed if the cooling fan in accordance with load, and to suppress noise caused by the cooling fan. The cooling fan controller includes a fluid temperature sensor 40 for sensing a temperature Tₒ of the fluid, an air temperature sensor 30 for sensing a temperature Tₐ of the air, and a control means 20 for calculating a difference between the fluid temperature Tₒ sensed by the fluid temperature sensor 40 and the air temperature Tₐ sensed by the air temperature sensor 30, and setting a target revolving speed N_{f} of the cooling fan in accordance with a magnitude of the calculated difference.

### TECHNICAL FIELD

The present invention relates to a controller, for controlling the revolving speed (number of revolutions) of a cooling fan, which is suitable for use in a cooling fan mounted in working machinery such as a hydraulic shovel.

### BACKGROUND ART

Working machines, such as a hydraulic shovel, are being used in urban areas and residential areas with ever-increasing frequency, so that machine noise during operation has become an important consideration. The generation of machine noise is greatly affected by the presence of a cooling fan that introduces the air as a cooling wind into cooling equipments such as an oil cooler and radiator.

Cooling fans are normally designed, taking a severe operating environment into account. For example, even when the air temperature is high such as 30° C. and an engine runs continuously in a condition of maximum load such as full throttle, the cooling ability of cooling equipments is raised by increasing the revolving speed of the cooling fan to admit a cooling wind at a higher volume into the cooling equipments so that the engine is not overheated.

However, if the revolving speed of the cooling fan is increased, the rotational resistance due to air will become great, and wind noise by revolution of the cooling fan will be increased. This will have a great influence on the generation of noise.

For noise reduction, it is preferable to make the revolving speed of cooling fans as low as possible except when necessary, such as high-load time, etc.

Because of this, a variety of techniques have been developed for controlling the revolving speed of a cooling fan.

For example, the revolving speed of a cooling fan is being controlled according to the temperature of hydraulic operating oil employed for the operation and travel of working machinery.

Furthermore, for example patent document 1, regarding construction machinery (working machinery), discloses a technique that controls the revolving speed of a cooling fan by a fan controller in accordance with the temperature (water temperature) T_{w} of engine-cooling water and the temperature (oil temperature) Tₒ of the hydraulic operating oil circulating through a hydraulic system.

More specifically, in the technique of the above patent document 1, the water temperature T_{w} is detected by a water-temperature sensor, and the oil temperature Tₒ is detected by an oil-temperature sensor. When the detected water temperature T_{w} and oil temperature Tₒ are smaller than predetermined first temperature Tw₁ and To₁, the cooling fan is not operated.

When the water temperature T_{w} is between the first temperature Tw₁ and a second temperature Tw₂ higher than the first temperature Tw₁ and the oil temperature To is smaller than the first temperature To₁, and when the water temperature T_{w} is smaller than the first temperature Tw₁ and the oil temperature Tₒ is between the first temperature To₁ and a second temperature To₂ higher than the first temperature To₁, the cooling fan is operated at low speeds.

When the water temperature T_{w} and oil temperature Tₒ are between the first temperatures Tw₁ and To₁ and the second temperature Tw₂ and To₂, the cooling fan is operated at intermediate speeds.

When the water temperature T_{w} is greater than the second temperature Tw₂ and the oil temperature Tₒ is between the first temperature To₁ and the second temperature To₂, when the water temperature T_{w} is between the first temperature Tw₁ and the second temperature Tw₂ and the oil temperature Tₒ is greater than the second temperature To₂, and when the water temperature T_{w} and oil temperature Tₒ are greater than the second temperatures Tw₂ and To₂, the cooling fan is operated at high speeds.

Patent Document 1: Japanese Patent laid-open publication No. HEI 5-288053

### DISCLOSURE OF THE INVENTION

### Problems to be Solved by the Invention

However, engine load (i.e., the generation of heat of an engine) is also affected by factors other than oil temperature and water temperature.

It is known that the cooling ability of the cooling equipments for cooling hydraulic operating oil or engine-cooling water is proportional to the temperature and volume of a cooling wind admitted by a cooling fan. That is, the cooler the cooling wind is and higher the wind volume is, the more efficiently the hydraulic operating oil or engine-cooling water is cooled.

However, for instance, in cooling hydraulic operating oil by a cooling wind with a predetermined volume, there are two situations. In one situation, oil temperature continues to hold about 70° C. when the temperature of the cooling wind is as low as 0° C. In another situation, oil temperature continues to hold about 70° C. when the temperature of the cooling wind is as high as 30° C. That is, there is a situation where oil temperature holds the same temperature though the cooling abilities by the cooling wind differ.

More specifically, the former situation means that the heating value of the hydraulic operating oil is large, i.e., it means that great work is performed on the hydraulic operating oil and thus the engine load is high. On the other hand, the latter situation means the heating value of the hydraulic operating oil is small, i.e., it means that little work is performed on the hydraulic operating oil and thus the engine load is low. For that reason, although the former situation is better in cooling ability than the latter situation, the hydraulic operating oil is cooled down to only the same oil temperature as that in the latter situation.

Therefore, if the revolving speed of the cooling fan is merely controlled by only oil temperature, there is a fear that, when the engine load is high, rotation of the cooling fan will be insufficient and therefore the engine will be overheated, or there is another fear that, when the engine load is not high, the cooling fan will be excessively rotated and therefore the machine noise will be increased.

In addition, strictly speaking, the control disclosed in the patent document 1 that is based on oil temperature and water temperature is not performed according to engine load. As a result, as described above, there is a fear that rotation of the cooling fan will be insufficient, or the cooling fan will be excessively rotated.

Thus, it is preferable that the revolving speed of a cooling fan be finely controlled according to engine load.

The present invention has been made in view of the problems described above. Accordingly, it is an object of the present invention to provide a cooling fan controller and a cooling fan controller for working machinery that optimally control the revolving speed of the cooling fan in accordance with load to suppress noise caused by the cooling fan.

### Means for Solving the Problems

To achieve this object and in accordance with the present invention as set forth in claim 1, there is provided a cooling fan controller for controlling a revolving speed of a cooling fan that introduces outside air as a cooling wind to cool a fluid being cooled. The cooling fan controller includes a fluid temperature sensor for sensing a temperature of the fluid; an air temperature sensor for sensing a temperature of the air; and control means for calculating a difference between the fluid temperature sensed by the fluid temperature sensor and the air temperature sensed by the air temperature sensor, and setting a target revolving speed of the cooling fan in accordance with a magnitude of the calculated difference.

The cooling fan controller of the present invention as set forth in claim 2 is characterized in that, in the controller as set forth in claim 1, the difference has a first reference difference and a second reference difference greater than the first reference difference as reference values;

the target revolving speed has a first minimum revolving speed as a first lower limit value and has a first maximum revolving speed as a first upper limit value; and

the control means

if the difference is less than or equal to the first reference difference, sets the target revolving speed at the first minimum revolving speed,

if the difference is greater than the second reference difference, sets the target revolving speed at the first maximum revolving speed, and

if the difference is greater than the first reference difference and less than or equal to the second reference difference, sets the target revolving speed at a revolving speed linearly interpolated between the first minimum revolving speed and the first maximum revolving speed in accordance with a magnitude of the difference.

The cooling fan controller of the present invention as set forth in claim 3 is characterized in that, in the controller as set forth in claim 2, the fluid temperature has a first reference fluid temperature and a second reference fluid temperature greater than the first reference fluid temperature as reference values;

the target revolving speed further has a second minimum revolving speed as a second lower limit value and further has a second maximum revolving speed as a second upper limit value; and

the control means

if the fluid temperature is less than or equal to the first reference fluid temperature, sets the target revolving speed at the second minimum revolving speed,

if the fluid temperature is greater than the second reference fluid temperature, sets the target revolving speed at the second maximum revolving speed, and

if the fluid temperature is greater than the first reference fluid temperature and less than or equal to the second reference fluid temperature, sets the target revolving speed at a revolving speed linearly interpolated between the second minimum revolving speed and the second maximum revolving speed in accordance with the magnitude of the fluid temperature, and

sets, as a final target revolving speed, the greater one of the target revolving speed based on the difference and the target revolving speed based on the fluid temperature.

The cooling fan controller for working machinery of the present invention as set forth in claim 4 is characterized in that the cooling fan controller as set forth in any of claims 1 through 3 is applicable to working machinery.

The cooling fan controller for working machinery of the present invention as set forth in claim 5 is characterized in that, in the cooling fan controller for working machinery as set forth in claim 4, the fluid is hydraulic operating oil employed for operation and travel of the working machinery.

### EFFECTS OF THE INVENTION

According to the cooling fan controller of the present invention as set forth in claim 1, in controlling the revolving speed of the cooling fan, the difference between the temperature of the fluid and the temperature of the air is employed, so a load on a driving source (e.g., a driving source for the cooling fan) that performs work on the fluid can be properly determined.

Since the target revolving speed of the cooling fan is set according to the determined load, the revolving speed of the cooling fan can be finely and optimally controlled. Accordingly, because the cooling fan is not rotated to more than necessity, machine noise that is generated by the cooling fan can be suppressed.

According to the cooling fan controller of the present invention as set forth in claim 2, a target revolving speed is set at a revolving speed linearly interpolated according to the magnitude of the difference between the fluid temperature and the air temperature, so the revolving speed of the cooling fan can be more finely controlled.

In addition, the target revolving speed has an upper limit value and a lower limit value, and if the difference is less than or equal to the first reference difference, the target revolving speed is set at the first minimum revolving speed. Further, if the difference is greater than the second reference difference, the target revolving speed is set at the first maximum revolving speed. Therefore, with the cooling ability being sufficiently ensured, noise can be suppressed, and fuel consumption can be improved.

According to the cooling fan controller of the present invention as set forth in claim 3, the greater one of the target revolving speed based on the difference between the fluid temperature and the air temperature and the target revolving speed based on the fluid temperature is determined as a final target revolving speed, so the revolving speed of the cooling fan can be more finely controlled. Therefore, with the cooling ability being sufficiently ensured, noise can be suppressed, and fuel consumption can be improved.

According to the cooling fan controller for working machinery of the present invention as set forth in claim 4, the revolving speed of the cooling fan mounted in working machinery can be optimally controlled. In the case where the cooling fan is driven by an engine that is a power source for working machinery, it is possible to reduce extra engine output that is consumed for driving the cooling fan.

According to the cooling fan controller for working machinery of the present invention as set forth in claim 5, the temperature of hydraulic operating oil on which a load on a machine body is easily reflected is employed, so a load on the engine can be determined with a high degree of accuracy.

### BRIEF DESCRIPTION OF THE DRAWINGS

FIG. 1 is a block diagram showing a cooling fan controller in accordance with a preferred embodiment of the present invention;

FIG. 2 is a flowchart showing the contents of control that is performed by the cooling fan controller of the preferred embodiment of the present invention;

FIGS. 3(a) and 3(b) are graphs showing the revolving speed of a cooling fan that is set by the cooling fan controller of the preferred embodiment of the present invention;

FIG. 3(c) is a graph showing the revolving speed of the cooling fan that is set by a conventional cooling fan controller;

FIGS. 4(a) to 4(c) are graphs showing the experimental results controlled by the cooling fan controller of the preferred embodiment of the present invention and the experimental results controlled by the conventional controller at the same time, FIG. 4(a) showing at high-load, FIG. 4(b) showing at intermediate-load, and FIG. 4(c) showing at low-load;

FIG. 5 is a perspective view showing a hydraulic shovel equipped with the cooling fan controller of the preferred embodiment of the present invention; and

FIG. 6 is a sectional view of the hydraulic shovel equipped with the cooling fan controller of the preferred embodiment of the present invention, taken along line A-A of FIG. 5.

### DESCRIPTION OF REFERENCE NUMERALS

1 Hydraulic shovel
2 Under carriage
3 Upper structure
3a Revolving frame
4 Working attachment
5 Counterweight
10 Engine
11 Hydraulic pump
12 Cooling equipment
13 Cooling fan
14 Fan-driving shaft
15 Viscous clutch (fluid coupling)
20 Controller (control means)
21 Calculator
22 Filter
23 Storage
24 First setter
25 Second setter
26 Determiner
27 Control device
30 Air temperature sensor
40 Oil temperature sensor (fluid temperature sensor)
N_{f} Revolving speed of a cooling fan (target revolving speed)
N_{fmin} Minimum revolving speed (first minimum revolving speed, second minimum revolving speed)
N_{fmax1} First maximum revolving speed
N_{fmax2} Second maximum revolving speed
ΔT Air-oil difference (difference)
ΔT₁ First reference air-oil difference (first reference difference)
ΔT₂ Second reference air-oil difference (second reference difference)
Tₒ Oil temperature
Tₒ₁ First reference oil temperature (first reference fluid temperature)
Tₒ₂ Second reference oil temperature (second reference fluid temperature)
Tₒ₃ Third reference oil temperature (third reference fluid temperature)
Tₐ Air temperature
Tₐₘᵢₙ Minimum air temperature
Tₒ₁′ Oil temperature at which a conventional target revolving speed rises

### BEST MODE FOR CARRYING OUT THE INVENTION

A preferred embodiment of the present invention will hereinafter be described with reference to the accompanying drawings.

### A PREFERRED EMBODIMENT

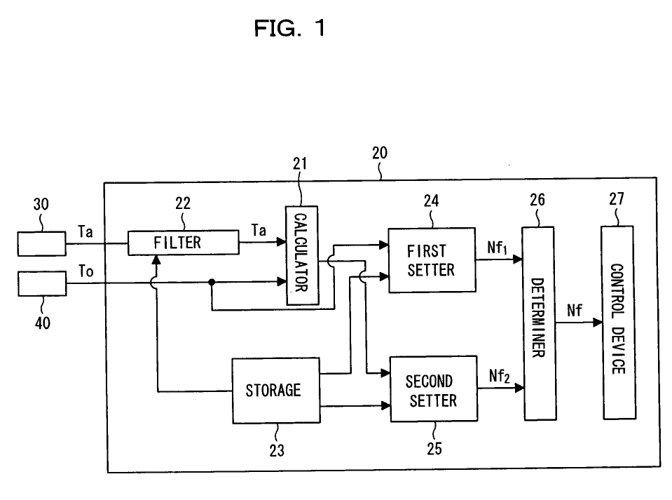

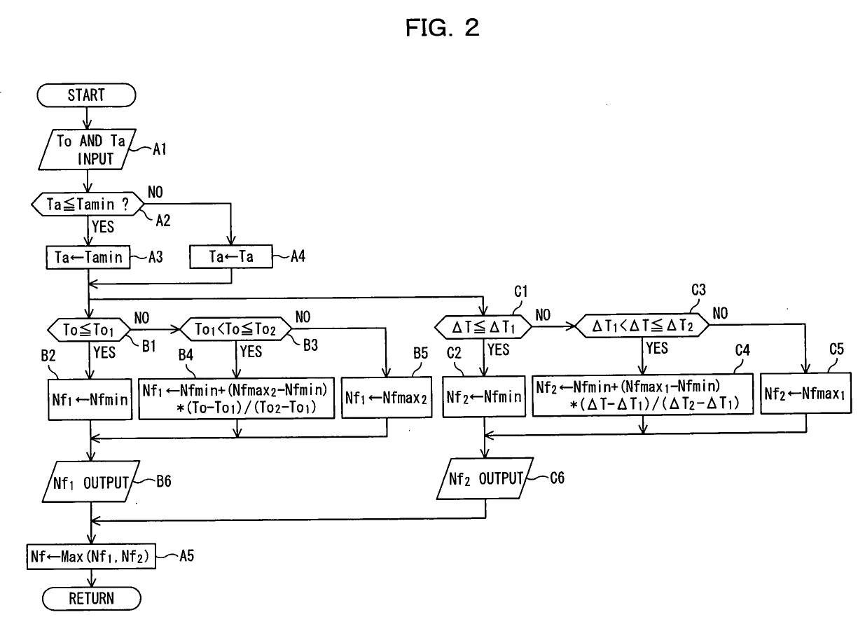

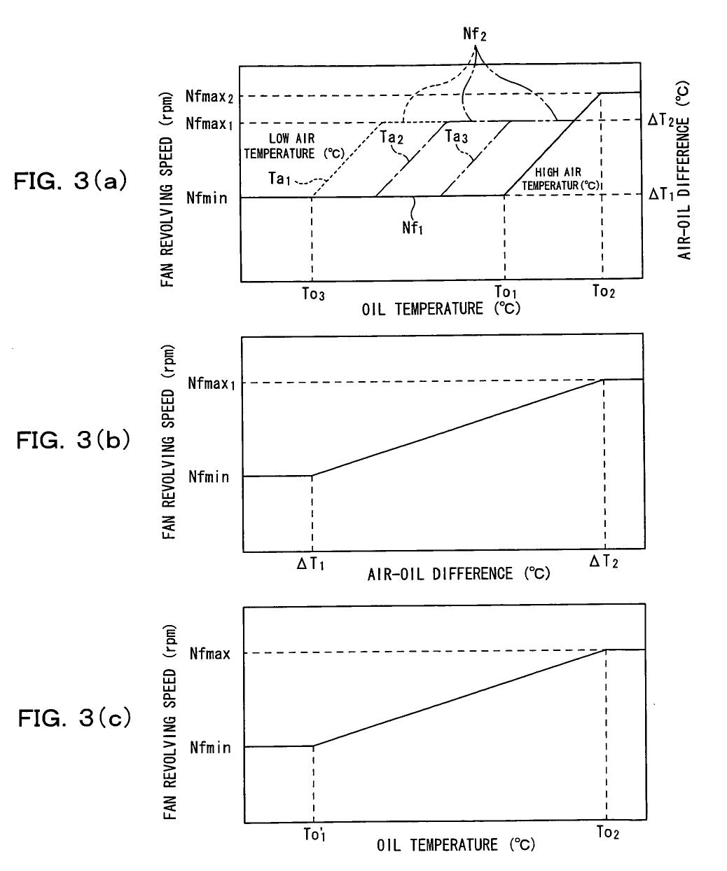

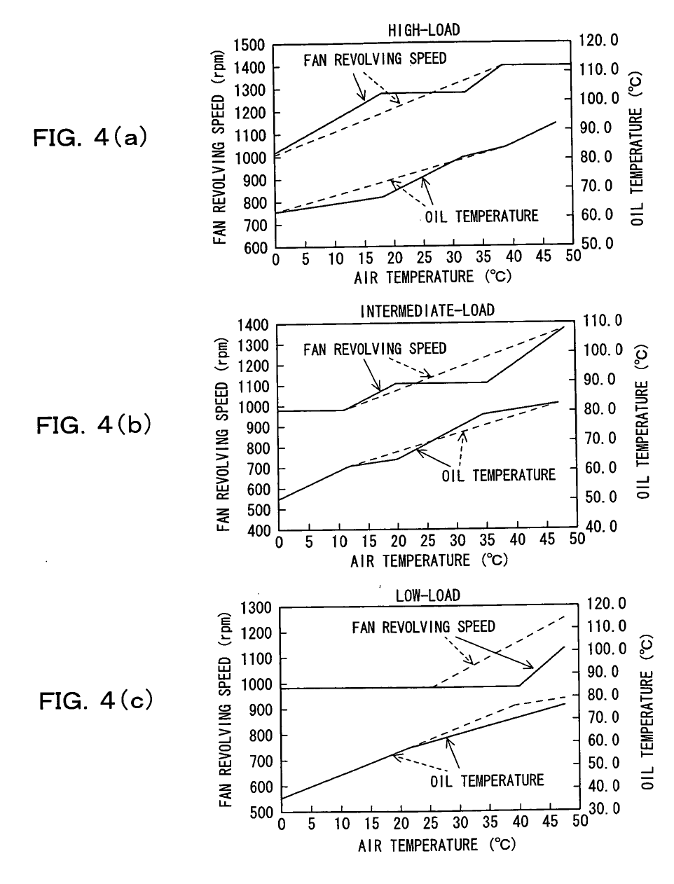

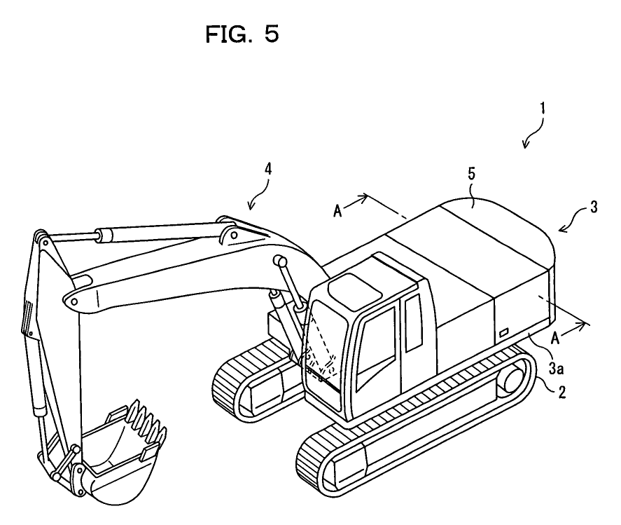

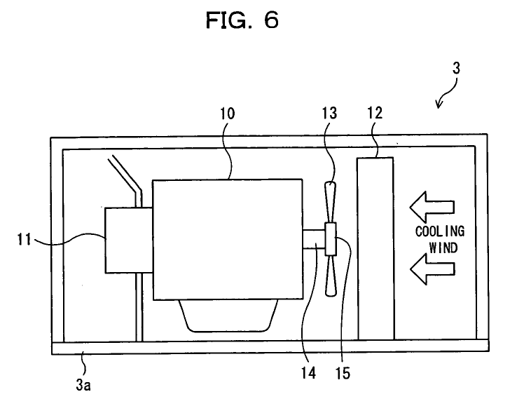

FIGS. 1 to 6 show a cooling fan controller in accordance with the preferred embodiment of the present invention. FIG. 1 is a block diagram showing the controller, FIG. 2 is a flowchart showing the contents of control which is performed by the controller, and FIGS. 3(a) and 3(b) are graphs showing the revolving speed (target revolving speed) of the cooling fan that is set by the controller, and FIG. 3(c) is a graph showing the revolving speed of the cooling fan that is set by a conventional cooling fan controller that employs only oil temperature information. FIGS. 4(a) to 4(c) are graphs showing the revolving speed of the cooling fan versus oil temperature, obtained by the experimental results controlled by the cooling fan controller and conventional controller, FIG. 4(a) showing at high-load, FIG. 4(b) showing at intermediate-load, and FIG. 4(c) showing at low-load. Also, FIG. 5 is a perspective view showing a hydraulic shovel equipped with the cooling fan controller; and FIG. 6 is a sectional view taken along line A-A of FIG. 5. Note in FIG. 6 that the sectional areas are shown without hatching.

<Structure>

In the preferred embodiment, a description is given of a controller for a cooling fan mounted in a hydraulic shovel 1 that is a typical example of working machinery.

As illustrated in FIG. 5, the hydraulic shovel 1 is constituted by an under carriage 2, an upper structure (machine body) 3 rotatably connected to the under carriage 2, and a working attachment 4, which extends forward from the upper structure 3.

The upper structure 3 has a revolving frame 3a as a mount, and a counterweight 5 placed on the rear end portion of the revolving frame 3a for balancing with the working attachment 4. In front of the counterweight 5, the upper structure 3, as shown in FIG. 6, contains an engine 10, which is a power source for the hydraulic shovel 1, a hydraulic pump 11, which is driven by the engine 10, a cooling equipment 12, such as a radiator in which engine-cooling water is cooled or an oil cooler used to cool hydraulic operating oil (fluid being cooled), a cooling fan 13 by which a cooling wind is introduced to a cooling equipment 12, a hydraulic operating oil tank (not shown), in which hydraulic operating oil is stored, and a controller (control means) 20 (see FIG. 1), which sets a target revolving speed (also called a fan revolving speed) N_{f} of the cooling fan 13.

The cooling fan 13, in order to be driven by the engine 10, is mounted on the driving shaft 14 (which is the same shaft as the driving shaft of the engine 10) through a viscous clutch (fluid coupling) 15 which is rotation-transmitting means.

The viscous clutch 15 is a device that exploits the shear of silicon oil whose viscosity is high, for generating torque in accordance with a differential revolving speed. That is, power of the rotation of the fan-driving shaft 14 creates the flow of silicon oil, which transmits power of the rotation to the cooling fan 13, but since slip occurs in the viscous clutch 15 because of the viscosity of silicon oil, all of the rotation power of the fan-driving shaft 14 is not transmitted and thus the cooling fan 13 is controlled to a revolving speed differing from that of the engine 10. The controller 20 is adapted to adjust the slip ratio of the silicon oil to control the revolving speed N_{f} of the cooling fan 13.

At an appropriate position on the machine body 3, an air temperature sensor 30 (see FIG. 1) is installed for sensing the surrounding temperature (outside air temperature) Tₐ during operation. To the hydraulic operating oil tank, an oil-temperature sensor 40 (see FIG. 1) is attached for sensing the temperature of the hydraulic operating oil (fluid temperature or oil temperature) Tₒ.

The air temperature Tₐ sensed by the air temperature sensor 30, and the oil temperature Tₒ sensed by the oil temperature sensor 40, are input to the controller 20.

The controller 20, as shown in FIG. 1, has a calculator 21 for calculating a difference ΔT between the input air temperature Tₐ and oil temperature Tₒ (hereinafter referred to as an air-oil difference ΔT), a filter 22 for filtering the air temperature Tₐ which is input to the calculator 21, a storage 23 for respectively storing the predetermined reference values (predetermined values) of the air temperature Tₐ, oil temperature Tₒ, and target revolving speed N_{f} of the cooling fan 13, a first setter 24 that uses only the oil temperature Tₒ to set a first target revolving speed N_{f1} of the cooling fan 13, a second setter 25 that uses the air-oil difference ΔT to set a second target revolving speed N_{f2} of the cooling fan 13, a determiner 26 for determining the greater of the two target revolving speeds N_{f1} and N_{f2} set by the first setter 24 or the second setter 25 as a final target revolving speed N_{f}, and a control device 27 for controlling the revolving speed of the cooling fan 13 so that it reaches the final target revolving speed N_{f} determined by the determiner 26.

To the calculator 21, the air temperature Tₐ filtered by the filter 22, and the oil temperature Tₒ sensed by the oil temperature sensor 40, are input. Then, the calculator 21 is adapted to output the air-oil difference ΔT calculated using the air temperature Tₐ and oil temperature Tₒ to the second setter 25. The air-oil difference ΔT correlates with the machine load (the load of engine 10) during operation. It has been found that the greater the air-oil difference ΔT, the higher the load.

The filter 22 is adapted to output the filtered air temperature Tₐ to the calculator 21. To the filter 22, the air temperature Tₐ sensed by the air temperature sensor 30, and hereinafter-mentioned the minimum air temperature Tₐₘᵢₙ stored in the storage 23, are input. The filter 22 first compares the sensed air temperature Tₐ with the minimum air temperature Tₐₘᵢₙ stored in the storage 23. If the sensed air temperature Tₐ is less than or equal to the minimum air temperature Tₐₘᵢₙ (Tₐ≦Tₐₘᵢₙ), the filter 22 outputs the minimum air temperature Tₐₘᵢₙ to the calculator 21 as the air temperature Tₐ. On the other hand, if the sensed air temperature Tₐ is greater than the minimum air temperature Tₐₘᵢₙ (Tₐ>Tₐₘᵢₙ), the filter 22 outputs the sensed air temperature Tₐ to the calculator 21 as the air temperature Tₐ. That is, the filter 22 is adapted to prescribe the lower limit value Tₐₘᵢₙ of the air temperature Tₐ that is input to the calculator 21.

The storage 23 stores a minimum revolving speed N_{fmin}, preset as the lower limit value of the target revolving speed N_{f} of the cooling fan 13, and a first maximum revolving speed N_{fmax1} and a second maximum revolving speed N_{fmax2}, preset as the upper limit values of the target revolving speed N_{f} of the cooling fan 13. The second maximum revolving speed N_{fmax2} is set at a higher value than the first maximum revolving speed N_{fmax1}. That is, the target revolving speed N_{f} has two-staged upper limit values N_{fmax}.

The storage 23 also stores a first reference air-oil difference (first reference difference) ΔT₁, and a second reference air-oil difference (second reference difference) ΔT₂ greater than the first reference difference ΔT₁, which are preset as a reference value of the air-oil difference ΔT. At the same time, the storage 23 stores a first reference oil temperature (first reference fluid temperature) Tₒ₁ and a second reference oil temperature (second reference fluid temperature) Tₒ₂ greater than the first reference oil temperature Tₒ₁, which are preset as a reference value of an oil temperature Tₒ.

The storage 23 further stores a minimum air temperature Tₐₘᵢₙ, preset as a reference value of an air temperature Tₐ.

The minimum air temperature Tₐₘᵢₙ is used for setting a minimum oil temperature Tₒ₃ at which control based on an air-oil difference ΔT is started by the second setter 25. It has been found that when the hydraulic operating oil is less than or equal to a certain oil temperature (third reference oil temperature) T₀₃, the hydraulic operating oil does not need to be cooled by raising the fan revolving speed N_{f}, from the viewpoint of hydraulic equipment performance, and that it is desirable from the viewpoint of noise and fuel consumption to fix the fan revolving speed at a minimum revolving speed N_{fmin} such that heat fatigue does not occur in hydraulic equipment. To meet such a demand, by setting a minimum air temperature Tₐₘᵢₙ, the cooling fan 13 is set the second target revolving speed N_{f2} at the minimum air temperature Tₐₘᵢₙ until the oil temperature Tₒ rises to the predetermined temperature Tₒ₃ by the second setter 25.

The first setter 24 receives the first reference oil temperature Tₒ₁, the second reference oil temperature Tₒ₂, the minimum revolving speed N_{fmin} and the second maximum revolving speed N_{fmax2} from the storage 23, and also is input the oil temperature Tₒ sensed by the oil temperature sensor 40.

Then, the first setter 24, as shown by solid lines in FIG. 3(a), when the oil temperature Tₒ is less than or equal to the first reference oil temperature Tₒ₁ (Tₒ≦Tₒ₁), is adapted to set the first target revolving speed N_{f1} at the minimum revolving speed N_{fmin}. Also, when the oil temperature Tₒ is greater than the second reference oil temperature Tₒ₂ (Tₒ>Tₒ₂), the first setter 24 is adapted to set the first target revolving speed N_{f1} at the second maximum revolving speed N_{fmax2}.

Furthermore, when the oil temperature Tₒ is greater than the first reference oil temperature Tₒ₁ and less than or equal to the second reference oil temperature Tₒ₂ (Tₒ₁<T₀≦Tₒ₂), as indicated by the following Eq. 1, the first setter 24 is adapted to set the first target revolving speed N_{f1} at a value linearly interpolated between the minimum revolving speed N_{fmin} and the second maximum revolving speed N_{fmax2} in accordance with the magnitude of the oil temperature Tₒ.

[Eq. 1]

N_{f1}=N_{fmin}+(N_{fmax2}−N_{fmin})×(Tₒ−Tₒ₁)/(Tₒ₂−Tₒ₁) (1)

That is, until the oil temperature Tₒ rises from the first reference oil temperature Tₒ₁ to the second reference oil temperature Tₒ₂, the first target revolving speed N_{f1} is caused to rise linearly from the minimum revolving speed N_{fmin} to the second maximum revolving speed N_{fmax2}. Note that the first reference oil temperature Tₒ₁ is set at a temperature higher than the oil temperature Tₒ₁′ at which the target revolving speed starts to rise in the conventional controller, shown in FIG. 3(c). The conventional controller is adapted to set the target revolving speed N_{f} by only the oil temperature Tₒ. As shown in FIG. 3(c), if the oil temperature Tₒ exceeds the predetermined oil temperature Tₒ₁′, the target revolving speed N_{f1} is caused to rise linearly at a predetermined gradient until it reaches the upper limit value N_{fmax}.

The second setter 25 receives the air-oil difference ΔT calculated in the calculator 21, and also receives the first reference air-oil difference ΔT₁, the second reference air-oil difference ΔT₂, the minimum revolving speed N_{fmin}, the first maximum revolving speed N_{fmax1}, and the minimum air temperature Tₐₘᵢₙ from the storage 23.

Then, the second setter 25, as shown in FIG. 3(b), when the air-oil difference ΔT is less than or equal to the first reference air-oil difference ΔT₁ (ΔT≦ΔT₁), is adapted to set the second target revolving speed N_{f2} at the minimum revolving speed N_{fmin}. Also, when the air-oil difference ΔT is greater than the second reference air-oil difference ΔT₂ (ΔT>ΔT₂), the second setter 25 is adapted to set the second target revolving speed N_{f2} at the first maximum revolving speed N_{fmax1}.

Furthermore, when the air-oil difference ΔT is greater than the first reference air-oil difference ΔT₁ and less than or equal to the second reference air-oil difference ΔT₂ (ΔT₁<ΔT≦ΔT₂), as shown by a dashed line, one-dot chain line, and two-dot chain line in FIG. 3(a) and as shown in FIG. 3(b), the second setter 25 is adapted to set the second target revolving speed N_{f2} at a value linearly interpolated between the minimum revolving speed N_{fmin} and the first maximum revolving speed N_{fmax1} in accordance with the air-oil difference ΔT.

[Eq. 2]

N_{f2}=N_{fmin}+(N_{fmax1}−N_{fmin})×(ΔT−ΔT₁)/(ΔT₂−ΔT₁) (2)

That is, as indicated by the above Eq. 2, the second target revolving speed N_{f2} is caused to rise linearly at a predetermined gradient until it reaches the first maximum revolving speed N_{fmax1}. In other words, the oil temperature Tₒ at which the second target revolving speed N_{f2} rises is shifted to a lower temperature side as the air temperature Tₐ becomes lower.

In FIG. 3(a), the air temperature Tₐ becomes lower as it goes toward the left side (Tₐ₁<Tₐ₂<Tₐ₃). The oil temperature Tₒ₃ at which the target revolving speed N_{f2} starts to rise is the addition of the first reference air-oil difference ΔT₁ to the minimum air temperature Tₐₘᵢₙ (Tₒ₃=Tₐₘᵢₙ+ΔT₁).

The determiner 26 is adapted to determine the greater one of the first and second target revolving speeds N_{f1} and N_{f2} input from the first and second setters 24 and 25 as the final target revolving speed N_{f}, and output the final target revolving speed N_{f} to the control device 27.

The control device 27 is adapted to set the slip ratio of the viscous clutch 15 in accordance with the final target revolving speed N_{f} input from the determiner 26, send the set signal to the viscous clutch 15, and control the cooling fan 13 so that the revolving speed reaches the final target revolving speed N_{f}.

<Action>

The cooling fan controller of the preferred embodiment of the present invention, as shown in FIG. 1, is constituted by the air temperature sensor 30, oil temperature sensor 40, and controller 20, and is controlled according to a processing procedure such as the one shown in FIG. 2.

As shown in FIG. 2, in step A1, the air temperature Tₐ sensed by the air temperature sensor 30 is input to the filter 22 of the controller 20, and the oil temperature Tₒ sensed by the oil temperature sensor 40 is input to the calculator 21 and first setter 24 of the controller 20. The processing procedure then advances to step A2.

In step A2, the filter 22 compares the input air temperature Tₐ with the minimum air temperature Tₐₘᵢₙ stored in the storage 23. If the input air temperature Tₐ is less than or equal to the minimum air temperature Tₐₘᵢₙ (Tₐ<Tₐₘᵢₙ), the processing procedure advances to step A3. On the other hand, if the air temperature Tₐ is greater than the minimum air temperature Tₐₘᵢₙ (Tₐ>Tₐₘᵢₙ), the processing procedure advances to step A4.

In step A3, the filter 22 outputs the minimum air temperature Tₐₘᵢₙ as the air temperature Tₐ to the calculator 21. The processing procedure then advances to step B1 and step C1.

In step A4, the filter 22 outputs the air temperature Tₐ sensed by the air temperature sensor 30 as the air temperature Tₐ to the calculator 21. The processing procedure then advances to step B1 and step C1.

In step B1, the first setter 24 determines whether the oil temperature Tₒ is less than or equal to the first reference oil temperature Tₒ₁ stored in the storage 23 (Tₒ≦Tₒ₁). If the answer is Yes (Tₒ≦Tₒ₁), the processing procedure advances to step B2. On the other hand, if the answer is No (Tₒ>Tₒ₁), the procedure advances to step B3.

In step B2, the first target revolving speed N_{f1} by oil-temperature control is set at the minimum revolving speed N_{fmin}.

In step B3, the first setter 24 determines whether the oil temperature Tₒ is less than or equal to the second reference oil temperature Tₒ₂ stored in the storage 23 (Tₒ≦Tₒ₂). If the answer is Yes (Tₒ₁<Tₒ≦Tₒ₂), the processing procedure advances to step B4. On the other hand, if the answer is No (Tₒ>Tₒ₂), the procedure advances to step B5.

In step B4, the first target revolving speed N_{f1} by oil-temperature control, as indicated by Eq. (1), is set by being interpolated linearly between the minimum revolving speed N_{fmin} and the second maximum revolving speed N_{fmax2} in accordance with the oil temperature Tₒ.

In step B5, the first target revolving speed N_{f1} by oil-temperature control is set at the second maximum revolving speed N_{fmax2}.

In step B6, the first setter 24 outputs the first target revolving speed N_{f1} by oil-temperature control to the determiner 26. Then, the procedure advances to step A5.

In step C1, the calculator 21 calculates a difference (air-oil difference) ΔT between the oil temperature Tₒ and the air temperature Tₐ, and inputs the difference ΔT to the second setter 25. Then, the second setter 25 determines whether the air-oil difference ΔT is less than or equal to the first reference air-oil difference ΔT₁ stored in the storage 23 (ΔT≦ΔT₁). If the answer is Yes (ΔT≦ΔT₁), the processing procedure advances to step C2. On the other hand, if the answer is No (ΔT>ΔT₁), the procedure advances to step C3.

In step C2, the second target revolving speed N_{f2} by air-oil difference control is set at the minimum revolving speed N_{fmin}.

In step C3, the second setter 25 determines whether the oil temperature Tₒ is less than or equal to the second reference air-oil difference ΔT₂ stored in the storage 23 (ΔT₁<ΔT≦ΔT₂). If the answer is Yes (ΔT₁<ΔT≦ΔT₂), the processing procedure advances to step C4. On the other hand, if the answer is No (ΔT>ΔT₂), the procedure advances to step C5.

In step C4, the second target revolving speed N_{f2} by air-oil difference control, as indicated by Eq. (2), is set by being interpolated linearly between the minimum revolving speed N_{fmin} and the first maximum revolving speed N_{fmax1} in accordance with the air-oil difference ΔT.

In step C5, the second target revolving speed N_{f2} by air-oil difference control is set at the first maximum revolving speed N_{fmax1}.

In step C6, the second setter 25 outputs the second target revolving speed N_{f2} by air-oil difference control to the determiner 26. Then, the procedure advances to step A5.

In step A5, the determiner 26 compares the first target revolving speed N_{f1} that was set according to the oil temperature Tₒ in step B6, with the second target revolving speed N_{f2} that was set according to the air-oil difference ΔT in step C6, and determines the greater one of the first target revolving speeds N_{f1} and the second target revolving speed N_{f2} as the final target revolving speed N_{f}.

The control device 27 performs control so that the revolving speed of the cooling fan 13 reaches the final target revolving speed N_{f} determined by the determiner 26.

This processing procedure is repeatedly executed at predetermined periods.

<Effects>

Thus, according to the cooling fan controller of the preferred embodiment, the greater one of the first target revolving speeds N_{f1} that is based on the oil temperature Tₒ and the second revolving speeds N_{f2} that is based on the air-oil difference ΔT is determined as the final target revolving speed N_{f}, so the cooling fan 13 can be controlled at the target revolving speed N_{f} shown in FIGS. 4(a) to 4(c). In these FIGS. 4(a) to 4(c), for comparison, the fan revolving speeds that are controlled based on only the oil temperature Tₒ by the conventional controller are indicated by dashed lines. Also, FIGS. 4(a) to 4(c), are graphs in case that the above mentioned parameters are set at N_{fmin}=980 rpm, N_{fmax1}=1400 rpm, N_{fmax2}=1280 rpm, Tₒ₁=76° C., Tₒ₂=84° C., Tₒ₁′=50° C., Tₐₘᵢₙ=20° C., ΔT₁=41° C., ΔT₂=47° C.

More specifically, as shown in FIG. 4(a), at high load (i.e., when the air-oil difference ΔT is comparatively great), the fan revolving speed N_{f} rises over approximately the entire range, compared with the conventional controller that is based on only the oil temperature Tₒ. Thus, cooling ability can be ensured.

In addition, as shown in FIG. 4(b), at intermediate load, the fan revolving speed N_{f} is suppressed over approximately the entire range, compared with conventional. Thus, revolution of the cooling fan 13 can be avoided with sufficient cooling ability being ensured.

As shown in FIG. 4(c), even at low load (i.e., even when the air-oil difference ΔT is comparatively small), the fan revolving speed N_{f} is suppressed over the entire range, compared with conventional. Thus, excessive revolution of the cooling fan 13 can be avoided with sufficient cooling ability being ensured.

Therefore, the revolving speed N_{f} of the cooling fan 13 is optimally controlled according to load, whereby noise and fuel consumption in operations at the time of low load and intermediate load can be improved with the cooling ability at the time of high load being ensured.

In addition, two maximum revolving speeds N_{fmax} are set so that when the air temperature Tₐ is high, the maximum revolving speed N_{f2} becomes higher than the maximum revolving speeds N_{f1} that is used during normal temperature. As a result, the engine 10 can be reliably prevented from being overheated.

Moreover, since the oil temperature Tₒ in hydraulic machinery is employed to calculate an air-oil difference ΔT between the air temperature Tₐ and the oil temperature Tₒ, information relating to machine load during operation can be properly exploited.

### [Other]

While the present invention has been described with reference to the preferred embodiment thereof, the present invention is not to be limited to the details given herein, but may be modified within the scope of the present invention hereinafter claimed.

For example, in the above mentioned embodiment, while the minimum revolving speed N_{fmin} in the first setter 24 and minimum revolving speed N_{fmin} in the second setter 25 are set at the same value, they may be set at different values.

In the above mentioned preferred embodiment, while the oil temperature sensor 40 is attached to the hydraulic operating oil tank, it may be installed at an appropriate position on the hydraulic circuit through which the hydraulic operating oil circulates.

In the above mentioned embodiment, while control is based on oil temperature, it may be replaced with the temperature of a fluid being cooled, such as engine-cooling water.

In the above mentioned embodiment, although the viscous clutch 15 is interposed between the fan-driving shaft 14 (which is the same shaft as the engine-driving shaft) and the cooling fan 13 so that the fan revolving speed is controlled to an arbitrary value, any type of clutch may be interposed so long as it is a clutch (fluid coupling) that can vary engine revolving speed and fan revolving speed.

The fan-driving shaft 14 may be formed separately from the engine-driving shaft. That is, in the above mentioned embodiment, cooling fan 13 revolves, using part of the driving force of the engine 10, but it may be driven by a dedicated electric motor. In this case, no clutch is required between the cooling fan 13 and the fan-driving shaft 14, and the controller 20 is able to control the fan revolving speed by controlling the revolving speed of the electric motor.

In the above mentioned embodiment, the cooling fan controller of the present invention is applied to the hydraulic shovel 1, but it may be varied in many ways so it can be applied to other working machines such as a bulldozer and a crane, and to various industrial products equipped with a cooling fan.

1. A cooling fan controller for controlling a revolving speed of a cooling fan that introduces outside air as a cooling wind to cool a fluid being cooled, comprising:
a fluid temperature sensor for sensing a temperature of said fluid;
an air temperature sensor for sensing a temperature of said air; and
control means for calculating a difference between said fluid temperature sensed by said fluid temperature sensor and said air temperature sensed by said air temperature sensor, and setting a target revolving speed of said cooling fan in accordance with a magnitude of said calculated difference.

2. The cooling fan controller as set forth in claim 1, wherein
said difference has a first reference difference and a second reference difference greater than said first reference difference as reference values;
said target revolving speed has a first minimum revolving speed as a first lower limit value and has a first maximum revolving speed as a first upper limit value; and
said control means
if said difference is less than or equal to said first reference difference, sets said target revolving speed at said first minimum revolving speed,
if said difference is greater than said second reference difference, sets said target revolving speed at said first maximum revolving speed, and
if said difference is greater than said first reference difference and less than or equal to said second reference difference, sets said target revolving speed at a revolving speed linearly interpolated between said first minimum revolving speed and said first maximum revolving speed in accordance with a magnitude of said difference.

3. The cooling fan controller asset for thin claim 2, wherein
said fluid temperature has a first reference fluid temperature and a second reference fluid temperature greater than said first reference fluid temperature as reference values;
said target revolving speed further has a second minimum revolving speed as a second lower limit value and further has a second maximum revolving speed as a second upper limit value; and
said control means
if said fluid temperature is less than or equal to said first reference fluid temperature, sets said target revolving speed at said second minimum revolving speed,
if said fluid temperature is greater than said second reference fluid temperature, sets said target revolving speed at said second maximum revolving speed, and
if said fluid temperature is greater than said first reference fluid temperature and less than or equal to said second reference fluid temperature, sets said target revolving speed at a revolving speed linearly interpolated between said second minimum revolving speed and said second maximum revolving speed in accordance with the magnitude of said fluid temperature, and
sets the greater one of the target revolving speed based on said difference and the target revolving speed based on said fluid temperature as a final target revolving speed.

4. The cooling fan controller for working machinery is characterized in that
the cooling fan controller as set forth in any of claims 1 through 3 is applicable to working machinery.

5. The cooling fan controller for working machinery as set forth in claim 4, wherein
said fluid is hydraulic operating oil employed for operation and travel of said working machinery.
